(19) United States
(12) Patent Application Publication
(10) Pub. No.: US 2006/0109511 A1
(43) Pub. Date: May 25, 2006

(54) Apparatus and method for forming logo on a surface

(76) Inventor: Rory Snyder, New York, NY (US)

Correspondence Address: JAMES RAY & ASSOCIATES, 2640 PITCAIRN ROAD, MONROEVILLE, PA, 15146, US

(21) Appl. No.: 11/284,076

(22) Filed: Nov. 21, 2005

Related U.S. Application Data
(60) Provisional application No. 60/629,644, filed on Nov. 19, 2004.

(51) Int. Cl. G06K 15/00

(52) U.S. Cl. 358/1.18

(57) ABSTRACT

An apparatus for forming a logo on a surface includes a template directly defining the logo or having an aperture formed therein for defining the logo. The template includes a plurality of fastening apertures for securing the template to the surface with elongated stakes. A coat of paint may be applied to a portion of the surface defined by the aperture in the template to form such logo. Alternatively, a contrasting material may be deposited onto the template positioned on the surface to form such logo. When the surface has a height associated therewith, a portion of the surface disposed adjacent the peripheral edge of the template may be reduced in height to create a raised logo.

### CROSS-REFERENCE TO RELATED APPLICATIONS

This application is related to and claims priory from Provisional Patent Application Ser. No. 60/629,644 filed Nov. 19, 2004.

### FIELD OF THE INVENTION

The present invention relates, in general, to an apparatus and method for marking a logo onto a surface and, more particularly, this invention relates to an apparatus and method for marking a logo onto a grass and/or a turf surface.

### BACKGROUND OF THE INVENTION

As is generally well known, logos are widely utilized, particularly in professional and amateur sports, to show affiliation with and support for a particular team. However, the known prior art fails to provide for an effective and economical apparatus and method for marking such logos in an outdoor environment and particularly on a grass or turf surface.

### SUMMARY OF THE INVENTION

The invention provides an apparatus for forming a logo on a surface. According to one aspect of the invention, the apparatus includes a template directly defining the logo. According to another aspect of the invention, such template has an aperture formed therein for defining the logo. The template of either embodiment may include a plurality of fastening apertures for securing the template to the surface with elongated stakes.

According to one method of the invention, a coat of paint is applied to a portion of the surface defined by the aperture in the template to form such logo.

According to another embodiment of the invention, a contrasting material is deposited onto the template positioned on the surface to form such logo.

According to yet another embodiment of the invention, when the surface has a height associated therewith, a portion of the surface disposed adjacent the peripheral edge of the template defining such logo may be reduced in height to create a raised logo.

### OBJECTS OF THE INVENTION

It is, therefore, one of the primary objects of the present invention to provide an apparatus and method for forming a logo on a surface.

Another object of the present invention is to provide an apparatus and method for forming a logo on an outdoor surface.

Yet another object of the present invention is to provide an apparatus and method for forming a logo on an outdoor surface which are economical to implement.

A further object of the present invention is to provide apparatus and method for forming a logo on an outdoor surface which will form a raised logo.

In addition to the several objects and advantages of the present invention which have been described with some degree of specificity above, various other objects and advantages of the invention will become more readily apparent to those persons who are skilled in the relevant art from the following more detailed description of the invention, particularly, when such description is taken in conjunction with the attached drawing Figures and with the appended claims.

### BRIEF DESCRIPTION OF THE DRAWINGS

FIG. 1 is a perspective view of an apparatus for forming a logo on a surface according to one embodiment of the invention;

FIG. 2 is a partial cross-sectional view of the apparatus for forming a logo on a surface along lines 2-2 of FIG. 1;

FIG. 3 is a perspective view of an apparatus for forming a logo on a surface according to another embodiment of the invention;

FIG. 4 is a front elevation view of the apparatus of FIG. 3 utilized for forming a raised logo according to one method of the invention; and

FIG. 5 is a front elevation view of the apparatus of FIG. 3 utilized for forming a raised logo according to another method of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a logo applies to alpha characters, numeric characters, alpha-numeric characters, graphics and various combinations thereof. It is to be further understood that the definition of a surface applies to an outdoor or indoor surface and, preferably more particularly, to grass, turf, ground cover and the like.

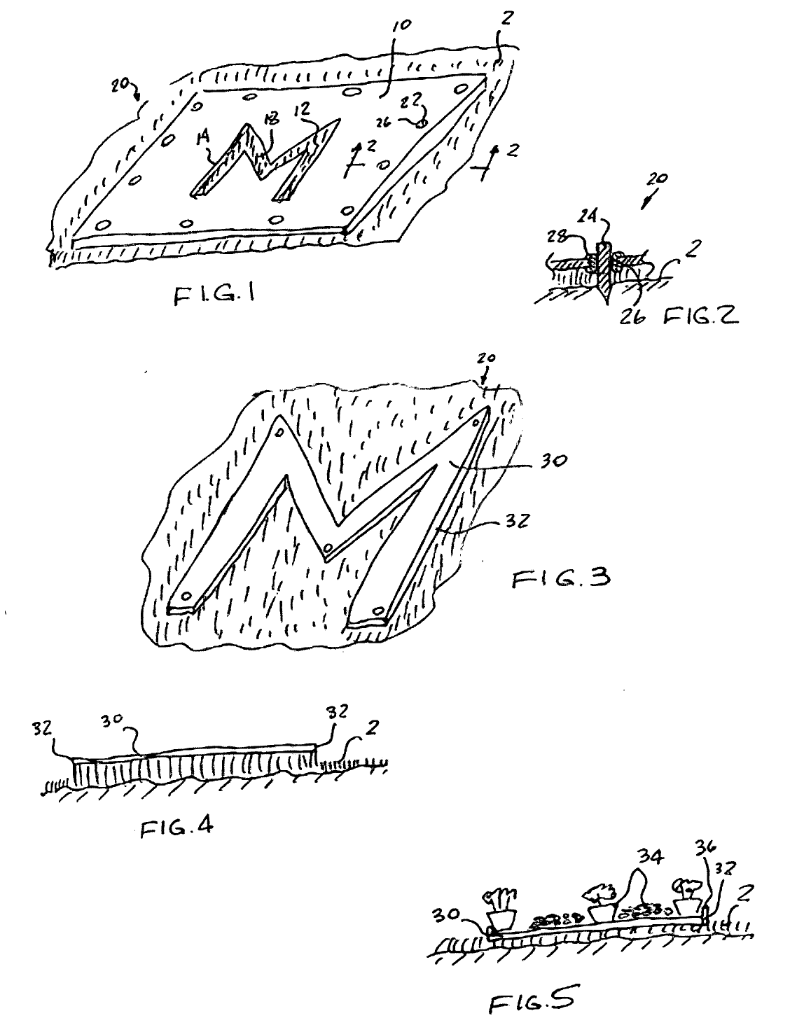

Reference is now made, to FIGS. 1-2, wherein there is shown a template 10, according to one embodiment of the invention, for forming logo 12 on a surface 2. Material of the template 10 may be one of paper, wood, fabric, plastic, rubber and various combinations thereof. Furthermore, such material may be flexible.

Such template 10 has an aperture 14 formed therethrough which defines such logo 12 to be formed on the surface 2. The template 10 further includes means, generally designated 20, engageable therewith for removably securing the template 10 to the surface 2. Such means 20, of the presently preferred embodiment, includes a first plurality of fastening apertures 22 disposed in a predetermined pattern in the template 10 and a second plurality of elongated members 24, each passing through a respective one of the first plurality of fastening apertures 22 for engagement, such as insertion, with the surface 2, as best shown in FIG. 2. The fastening aperture 22 may be adapted with means 28, such as a grommet 28, for reinforcing a peripheral edge 26 of the fastening aperture 22.

Preferably, the first plurality of fastening apertures 22 are disposed adjacent a peripheral edge of the template 10.

To utilize the template 10 for forming the logo 12 onto the surface 2, such template 10 is positioned on the surface 2 and at least one coat of paint 18 is applied onto a portion of the surface 2 which is exposed by the aperture 14. The template 10 is then removed to expose the logo 12 formed on the surface 2 by the at least one coat of paint 18.

It will be appreciated that such template 10 may be secured to the surface 2 with the securing means 20 prior to application of the at least one coat of paint 18. It will be further understood that the sizes of the fastening apertures 22 and elongated members 24 are minimized to limit depressions formed in the surface 2 by engagement of such elongated members 24.

Furthermore, such at least one coat of paint 18 may be allowed to dry prior to removal of the template 10.

A template 30, according to another embodiment of the invention, is best shown in FIGS. 3-5. Such template 30 has a predetermined shape substantially equal to the shape of the logo 12 and may be provided with securing means 20.

The template 30 may be utilized for forming raised logo 12 on the surface 2 having a height associated therewith by first positioning the template 30 onto the surface 2 and then using a peripheral edge 32 as a guide to decrease the height of at least a portion of the surface 2 disposed adjacent such peripheral edge 32, as best shown in FIG. 4. When such surface 2 is a grass surface 2, the height adjacent the peripheral edge 32 can be decreased first by using a trimmer (not shown) and then a mower (not shown).

Advantageously, a second template 10 having an aperture 14 formed according to the predetermined shape of the template 30 may be provided for applying the at least one coat of paint 18 onto the raised logo 12 formed in the surface 2 by first positioning such second template 10 onto a portion of the surface 2 having a decreased height and aligning the edge of the aperture 14 with the peripheral edge of the raised logo 12.

Now, in reference to FIG. 5, the template 30 may be further utilized for forming a raised logo 12 on the surface 2 by first positioning such template 30 on the surface 2 and the depositing at least one material 34 selected from a group consisting of mulch, stones, flowers, and ground cover onto the template 30. Height of the material 34 deposited onto the template 30 may be one of smaller, equal and greater then the height of the surface 2 disposed adjacent the peripheral edge 32 of the template 30. Such peripheral edge 32 may be at least partially provided with a lip 36 for at least partially containing such material 34 within confines of the template 30.

Those skilled in the art will appreciate that a portion of the template 10 removed during forming of the aperture 14 may form the template 30.

Those skilled in the art will further appreciate that utilization of the template 10 or the template 30 according to the methods described supra will provide for economical forming of the logo 12.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A method for forming a logo on a surface, said method comprising the steps of:
(a) providing a template having an aperture defining said logo;
(b) positioning said template onto said surface;
(c) applying at least one coat of paint onto a portion of said surface exposed by said aperture; and
(d) removing said template from said surface to expose said logo.

2. The method, according to claim 1, wherein said method further includes a step of providing means engageable with said template for removably securing it to said surface prior to application of said at least one coat of paint in step (c).

3. The method, according to claim 2, wherein said securing means includes a first plurality of fastening apertures disposed in a predetermined pattern in said template and a second plurality of elongated members each passing through a respective one of said first plurality of fastening apertures for engagement with said surface.

4. The method, according to claim 3, wherein each of said first plurality of fastening apertures includes a reinforcing means disposed therein for protecting a peripheral edge thereof.

5. The method, according to claim 3, wherein said reinforcing means is a grommet.

6. The method, according to claim 3, wherein said first plurality of fastening apertures are disposed adjacent a peripheral edge of said template.

7. The method, according to claim 2, wherein said method includes a step of removably securing said template to said surface prior to application of said at least one coat of paint in step (c).

8. The method, according to claim 1, wherein a material of said template is one of paper, wood, fabric, plastic, rubber and various combinations thereof.

9. The method, according to claim 1, wherein said surface is one of grass, turf, ground cover and various combinations thereof.

10. The method, according to claim 1, wherein said method further includes a step of enabling said at least one coat of paint to dry prior to removal of said template in step (d).

11. A method for forming a raised logo on a surface having a height associated therewith, said method comprising the steps of:
(a) providing a template defining said logo;
(b) positioning said template onto said surface;
(c) decreasing said height of at least a portion of said surface disposed adjacent a peripheral edge of said template; and
(d) removing said template from said surface.

12. The method, according to claim 11, wherein said method further includes the steps of:
(a) providing a second template having an aperture formed therein for defining said logo;
(b) positioning said second template onto a portion of said surface having a decreased depth to align said aperture with said logo; and
(c) applying at least one coat of paint onto said raised logo formed in said surface.

13. A method for forming a logo on a surface, said method comprising the steps of:
(a) providing a template defining said logo;
(b) positioning said template onto said surface; and
(c) depositing at least one material selected from a group consisting of mulch, stones, flowers, and ground cover onto said template.

14. The method, according to claim 13, wherein a height of said material deposited onto said template is one of smaller, equal and greater than a height of said surface disposed adjacent a peripheral edge of said logo.

15. The method, according to claim 13, wherein said template includes a lip at least partially extending from a peripheral edge of said template for at least partially containing said material deposited in step (c) within confines of said template.
